(19) United States
(12) Patent Application Publication
(10) Pub. No.: US 2014/0326917 A1
(43) Pub. Date: Nov. 6, 2014

(54) INK COMPOSITION

(71) Applicant: INDIAN INSTITUTE OF TECHNOLOGY, JODHPUR, JODHPUR (IN)

(72) Inventors: Shubhi Srivastava, Jodhpur (IN); Belal Usmani, Jodhpur (IN); Ritesh Patil, Jodhpur (IN); Seshadri Harinipriya, Jodhpur (IN)

(73) Assignee: INDIAN INSTITUTE OF TECHNOLOGY, JODHPUR, JODHPUR (IN)

(21) Appl. No.: 14/183,356

(22) Filed: Feb. 18, 2014

(30) Foreign Application Priority Data
May 1, 2013 (IN) 1293/DEL/2013

(51) Int. Cl. C09D 11/00; C09K 5/14

(52) U.S. Cl. CPC C09D 11/52; C09K 5/14
USPC 252/76; 252/500; 252/519.32; 252/511

(57) ABSTRACT

An ink composition for printing on a substrate is disclosed. The ink composition comprises a conductive material, ethyl cellulose as a binder; and a solvent selected from the group consisting of isoamylacetate and isoamylacetate-water mixture.

### FIELD

The disclosure relates to an ink composition for coating on a substrate. More specifically, the disclosure relates to an ink composition comprising a thermally and/or electrically conductive material and a specific binder and a solvent.

### BACKGROUND

Recently, electrically and/or thermally conductive inks are gaining demand by the electronics industry with potential applications in photovoltaics, transistors, displays, batteries, antennas and sensors. Recent efforts have focused on the design of conductive inks for integration on plastic, textile, and paper substrates. Typically, these conductive inks are manufactured by dispersing a conductive material in a binder and applying the mixture as a coating over a clear substrate. The binder holds the conductive material together and the solvent is used to dissolve the binder so the ink can be applied by a printing method.

US2004/0149959 discloses a conductive ink prepared by first preparing flakes of conductive material from oligomeric release agents and the conductive material precursor which is then dispersed in a binder to form the conductive ink. US 2011/0155812 discloses an aqueous conductive ink composition comprising conductive particles, styrene/(meth)acrylic copolymer, an anionic wetting agent, defoamer and water. U.S. Pat. No. 7,968,011 discloses a conductive ink comprising a conductive material and at least one solvent based polyurethane system.

A disadvantage of these prior art binder-solvent systems is that they often still require combining with several other binders, solvents or ingredients to get a good balance of properties such for example adhesion, flexibility, chemical resistance etc. Also, the prior art inks often exhibit drawbacks such as sensitivity to temperature and substrate and accordingly have limited applications. Another disadvantage of the conventional conductive inks is that water based ink formulations cannot be prepared and most of the ink compositions are based on organic solvents of high volatility and cost. A further disadvantage of the existing ink compositions is that they cannot be applied to flexible substrates.

Accordingly, there is a need for electrically and/or thermally conductive ink compositions which can be utilized for various applications while exhibiting high conductivity properties and being inexpensive. Other desired properties of conductive inks include good abrasion and chemical resistance when dried/cured/annealed so that they are not easily scratched or wiped off during use.

### SUMMARY

An ink composition for printing on a substrate is disclosed. The said ink composition comprises a conductive material, ethyl cellulose as a binder; and a solvent selected from the group consisting of isoamylacetate and isoamylacetate-water mixture.

A method for preparing the afore-said ink composition is also disclosed. The said method comprises mixing a conductive material with ethyl cellulose in a solvent selected from the group consisting of isoamylacetate and isoamylacetate-water mixture.

### BRIEF DESCRIPTION OF DRAWINGS

FIG. 1 illustrates the graph of heat flow vs. temperature of the ink composition of the present invention prepared in Example 1 using CaCl₂ as conductive material.

FIG. 2 illustrates the graph of heat flow vs. temperature of the ink composition of the present invention prepared in Example 2 using SrCl₂ as conductive material.

FIGS. 3A and 3B illustrates the scanning electron microscopy of spray coated ink composition of the present invention prepared in Example 1 using CaCl₂ as conductive material.

FIG. 4 illustrates the scanning electron microscopy of spray coated ink composition of the present invention prepared in Example 2 using SrCl₂ as conductive material.

FIG. 5A-5D illustrates the Simultaneous Thermal Analysis of ink composition of the present invention prepared in accordance with Example 3.

FIG. 6 illustrates via tafel plots, the corrosion analysis of the ink composition of the present invention prepared in accordance with Example 3.

FIG. 7 illustrates the cyclic voltammetry analysis of the ink composition of the present invention prepared in accordance with Example 3.

### DETAILED DESCRIPTION

To promote an understanding of the principles of the invention, reference will be made to the embodiment and specific language will be used to describe the same. It will nevertheless be understood that no limitation of scope of the invention is thereby intended, such alterations and further modifications in the described product and such further applications of the principles of the inventions as disclosed therein being contemplated as would normally occur to one skilled in art to which the invention relates.

The present disclosure generally relates to ink compositions comprising an electrically and/or thermally conductive material and a binder in a solvent for applications in the field of printed electronics. The ink composition of the present disclosure uses a specific binder and a specific solvent for forming an ink composition for various applications. Here, the binder is ethylcellulose and the solvent is selected from the group consisting of isoamylacetate and isoamylacetate-water mixture.

In accordance with an aspect, using the specific combination of ethylcellulose and solvent selected from the group consisting of isoamylacetate and isoamylacetate- water exhibits a synergistic effect which allows preparing both thermally and/or electrically conductive ink compositions for applications on numerous substrates and specifically on flexible substrates. In addition, the combination of the binder with the specific solvent produces ink composition which exhibit high porosity without any agglomeration.

Herein, ethyl cellulose as binder assists in the adhesion of the conductive particles to the substrate via a subsequent curing step and the solvent i.e. of isoamylacetate and isoamylacetate-water mixture plays the role of dissolving the binder as well as the conducting material. When the binary mixture of isoamylacetate and water is used, isoamylacetate serves to dissolve ethyl cellulose and the water plays the role of dissolving the conductive material.

In accordance with an embodiment, the ink composition may further comprise additional ingredients, including, but not limited to, humectants, plasticizers, defoamers, surfactants ad adhesion promoters.

In accordance with an embodiment, the ink composition comprises at least 75% by weight of conductive material. In accordance with a related embodiment, the conductive material and the binder are in a weight ratio in the range of 4:1 to 8:1. The ratio of the conductive material to the binder will depend on the type of conductive material and the desired level of conductivity and other attributes.

The solvent can be present in suitable amount, for example, in an amount greater than 25%, and is preferably 25%. In accordance with an embodiment, when the solvent is isoamylacetate-water mixture, the water is present in the mixture in an amount in the range of 10 to 25% and is preferably 25%.

The ink composition preferably has a viscosity in the range of 50 to 1000 m Pa·s and more preferably 200 m Pa·s at 30 degree Celsius.

In accordance with an aspect, the conductive material is a thermally and/or electrically conductive material selected from the group consisting of a metal, metal salt, polymer and ceramic. Any known conductive metal particles may be used in the composition of this invention, such as copper, gold, nickel, carbon, graphite, silver alloys, silver plated metals such as silver coated copper and silver coated nickel, silver coated glass, silver coated mica, silver coated graphite, nickel coated carbon, nickel coated graphite, and other conductive particles known in the field. Alternatively, carbon, typically in the form of carbon black, graphite, carbon nanotubes may also be used, alone or in combination with the metal particles. The ink composition can also be obtained using materials like multi-walled carbon nanotubes (MWCNTs), lithium ion battery cathode material (lithium manganese oxide), inorganic salts like CaCl₂, SrCl₂ etc. Preferably, the conductive material is in powder form. In accordance with a related embodiment, the particle size of the conductive material is in the range of 1 nm to 0.5 μm and is preferably in the range of 1-100 nm.

In accordance with an aspect, the substrate may be made of any polymer, glass or metal. In accordance with a related embodiment, the substrate is a flexible substrate. The substrate may be a polymer selected from the group consisting of a polyester, polyethylene, polypropylene, polyamide, polyimide, polyetherimide, polyurethane, polycarbonate, cellulosic ester (e.g. cellulose acetate etc.), polystyrene and styrenic copolymers. Further, the substrate may be a metallic substrate selected from stainless steel, copper, aluminum.

A method of preparing the ink composition described above is also disclosed. The said method comprises mixing a conductive material with ethyl cellulose in a solvent selected from the group consisting of isoamylacetate and isoamylacetate- water mixture.

In accordance with a preferred embodiment, the method of preparing the ink composition comprises adding the conductive material to a dispersion of binder in the solvent along with stirring. Alternatively, the conductive particles can be first mixed with the binder followed by dispersing in the solvent.

In accordance with an embodiment, the conductive material and the binder may be dispersed in the solvent with or without heating. In accordance with a preferred embodiment, the conductive material and binder in the solvent are maintained at a temperature in the range of 30° C. to 80° C. and more preferably at 65° C. to cause the dispersion thereof in the solvent.

In accordance with an aspect, various known methods of applying the ink composition to a substrate to form a conductive layer including coating, spraying, printing, and painting may be used. The ink composition may be applied to substrates by a variety of techniques such as screen printing, inkjet printing, offset printing, lithographic printing, letterpress printing, spraying, spin coating, brushing (painting), or curtain coating. Preferred printing techniques applicable to this composition include spray coating and spin coating. This allows achieving uniform adhesion and coating of the ink composition on the ink substrate using lesser amount of conductive material. A further advantage of using spray coating or spin coating is that scaling up is easier. The composition once applied to the substrate can be dried using a number of techniques and methods known in the field.

In accordance with an embodiment, the conductive material is selected from Calcium chloride and Strontium chloride. Using the conductive materials—Calcium chloride and Strontium chloride along with ethylcellulose in isoamylacetate-water mixture allows preparing thermally conductive inks for solar thermal absorber coatings, solar cooling applications i.e. vapor absorption refrigeration systems. In accordance with a related embodiment, when the conductive material is selected from Calcium chloride and Strontium chloride, activated charcoal is also added to the ink composition. In accordance with another related embodiment, the conductive material, activated charcoal and ethyl cellulose are in the weight ratio in the range of 1:0.25:0.25 and preferably are in a weight ratio of 4:1:1.

In accordance with an embodiment, when the conductive material is lithium manganese oxide (LiMn₂O₄), multi walled carbon nanotubes; the conductive material and ethyl cellulose are in a weight ratio in the range of 6:1 to 4:1 and are preferably in the weight ratio of 4:1.

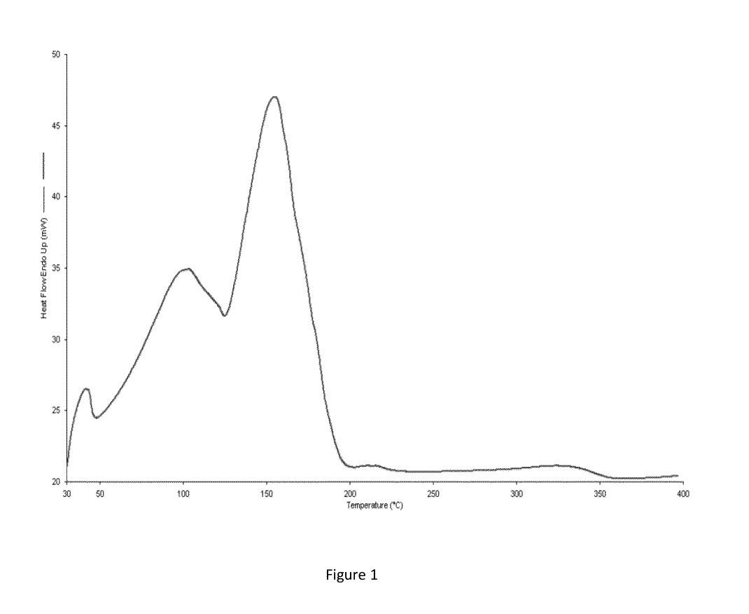

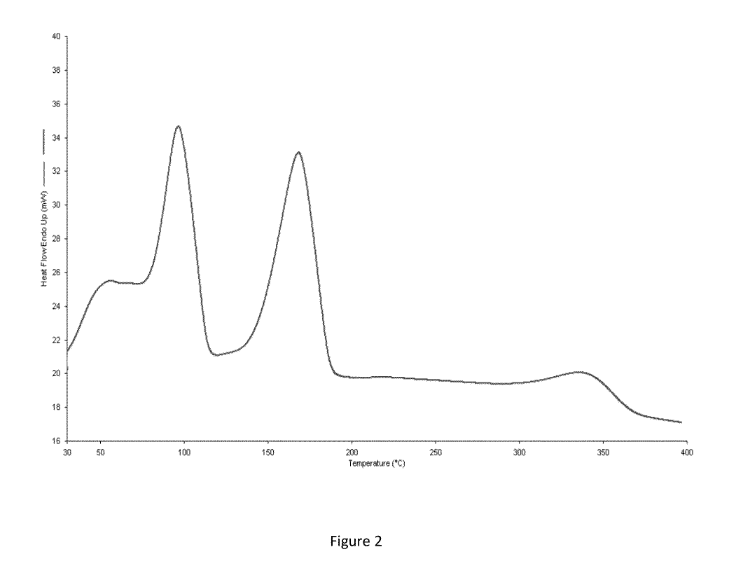

In accordance with an aspect, thermal characterization of the ink compositions prepared in accordance with Example 1 and 2 was performed by Differential Scanning Calorimetry. FIGS. 1 and 2 illustrate the heat flow vs. temperature graph of the ink compositions prepared using CaCl₂ and SrCl₂respectively.

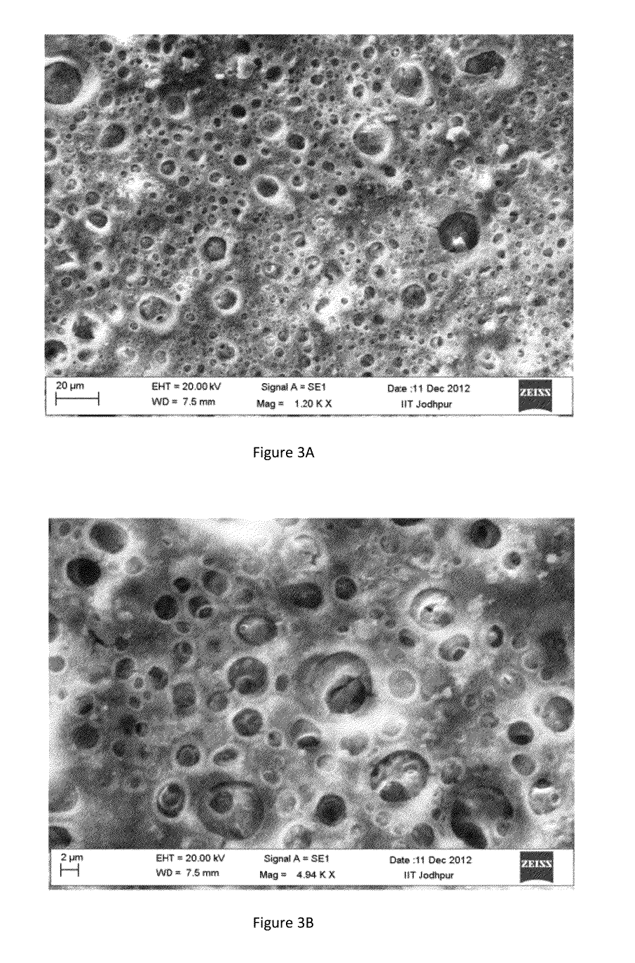

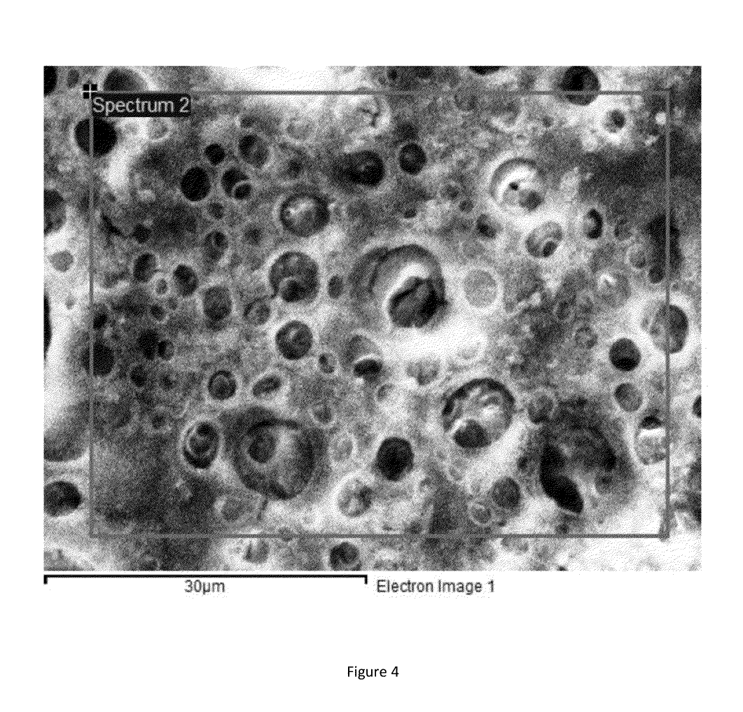

FIGS. 3A, 3B and 4 illustrate the scanning electron microscopy (SEM) of spray coated ink compositions prepared using CaCl₂ and SrCl₂ in Example 1 and 2 respectively. SEM of spray coated CaCl₂ ink as thin film on Stainless Steel up to 10 layers, shows very high porosity as required for the solar cooling applications.

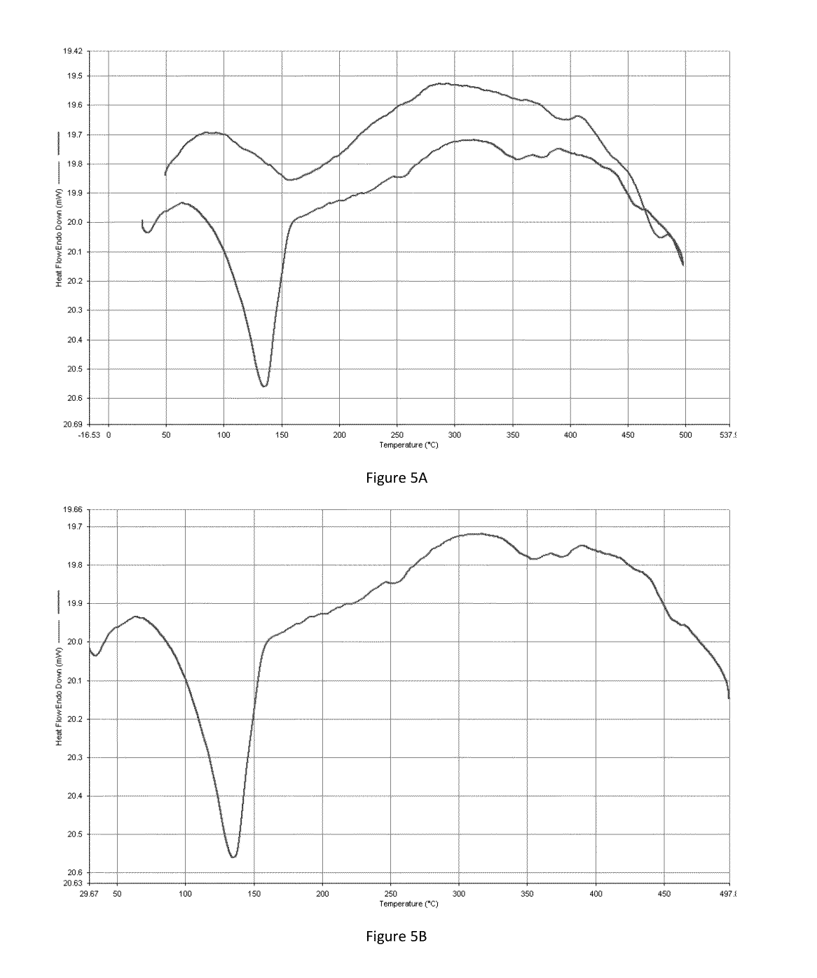

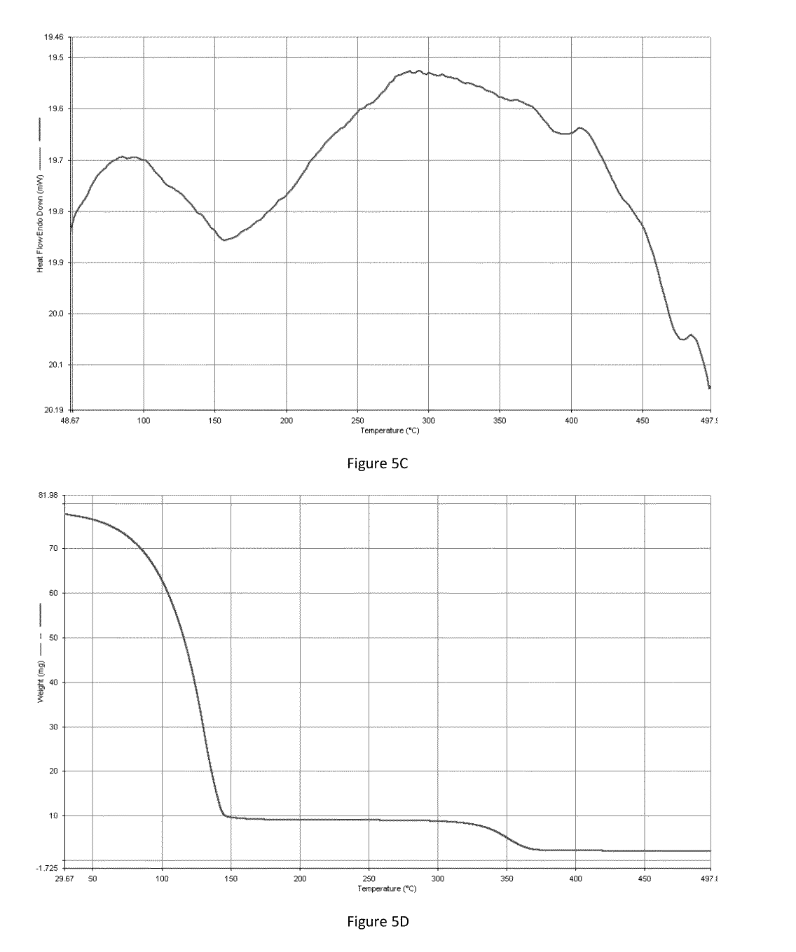

FIG. 5A-5D illustrates the Simultaneous Thermal Analysis of ink composition prepared in accordance with Example 3. As illustrated in the figure, weight loss takes place at a very high rate initially i.e. till 150 degree Celsius and then stabilizes. Further, the reaction is endothermic in nature.

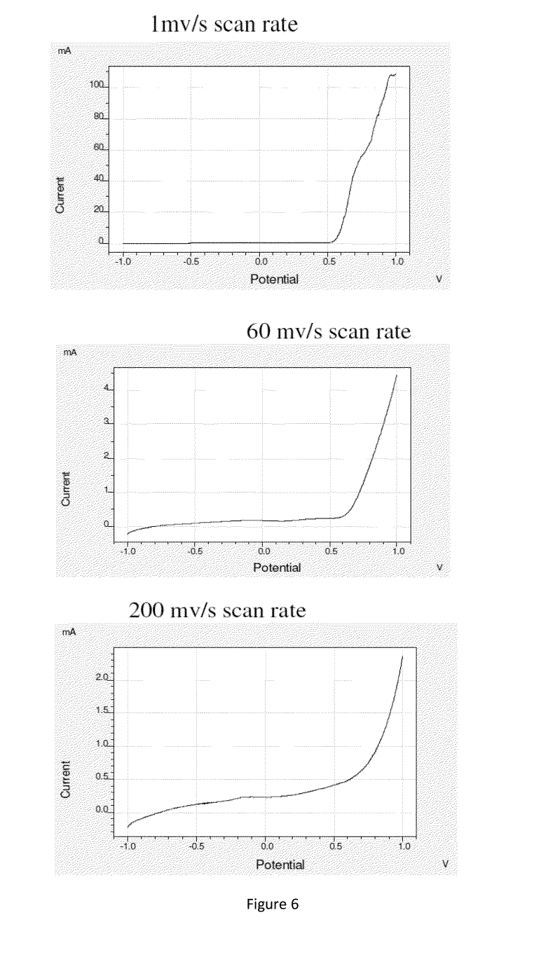

FIG. 6 illustrates the corrosion analysis of the ink composition prepared in accordance with Example 3, via tafel plots. The said tafel plots were obtained using IVIUMSTAT spectro-electrochemical workstation with coated stainless steel prepared in Example 3 as the working electrode, Ag/AgCl as the reference electrode, Platinum as the counter electrode in 3.5 M NaCl solution.

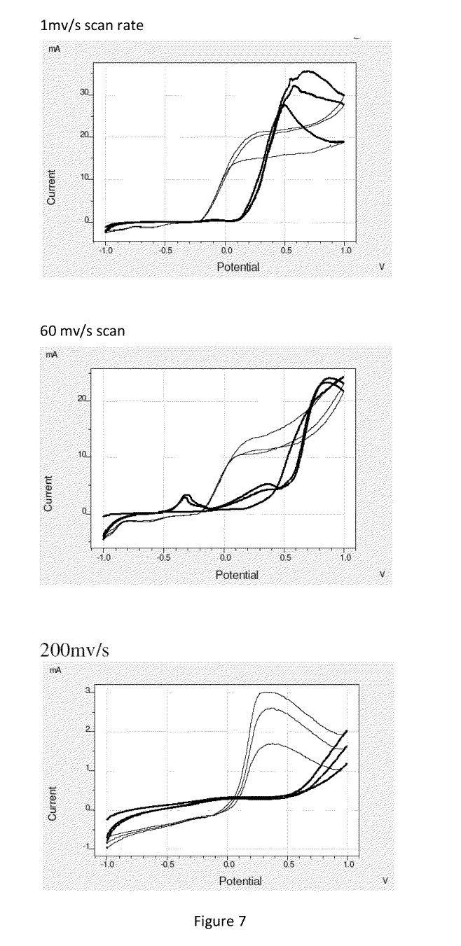

FIG. 7 illustrates the cyclic voltammetry analysis of the ink composition prepared in accordance with Example 3. The said cyclic voltammetry analysis was performed using coated stainless steel prepared in Example 3 as the working electrode, Ag/AgCl as the reference electrode, Platinum as the counter electrode in 3.5 M NaNO₃ solution. The zeta potential calculation from the cyclic voltammetry measurements shows that a high potential can be obtained at a slower scan rate. The potential decreases with the increase in scan rate.

The following examples are provided to explain and illustrate preferred embodiments of the process of the present invention:

### EXAMPLE 1

### Ink Composition Comprising: CaCl₂ as Conductive Material Ink Preparation

CaCl₂, activated carbon and ethyl cellulose are taken in the weight ratio of 4:1:1 (CaCl₂: Activated Carbon: Ethyl Cellulose). A mixture of 8 grams of CaCl₂ and 2 grams of activated charcoal was ground. The mixture was then dissolved in 100 ml distilled water with magnetic stirring at 60 degree Celsius for 30 minutes to obtain a Solution A. Another solution B was prepared using 2 grams of ethyl cellulose in 100 ml isoamyl acetate with magnetic stirring at 60 degree Celsius for 30 minutes. Solutions A and B were mixed with magnetic stirring at 65 degree Celsius for 2 hours to obtain the ink composition of the present invention.

### Spray Coating of the Ink Composition on Finned Tubes: at a Pressure of 60 to 70 psi

Spray coating of the ink composition was done in accordance with the following steps:
1. The above prepared ink is filled in spray gun and spray coated in between the fins of the finned tubes
2. After one layer of coating, the coating is allowed to dry in the oven at 70 degree

Celsius for 1 hour.
3. After 2nd layer of coating the coating is allowed to dry in the oven at 70 degree Celsius for 1 hour.
4. the above step is repeated till the completion of 11th layer
5. After 12th layer of coating, the coating is allowed to dry in oven at 100 degree Celsius for 30 minutes.
6. the above step is repeated till the completion of 17th layer
7. After 18th layer of coating, the coating is allowed to dry in the oven at 80 degree Celsius for 45 minutes.
8. The above step is repeated till the completion of 24th layer.
9. After 25th layer of coating, the coating is allowed to dry in the oven at 80 degree Celsius for 1 hour.
10. After 26th layer of coating, the coating is allowed to dry in the oven at 70 degree Celsius for 1 hour
11. The above step is repeated till the completion of 28th layer.

### EXAMPLE 2

### Ink Composition Comprising: SrCl₂ as Conductive Material

Ink preparation: SrCl₂, activated carbon and ethyl cellulose are taken in the weight ratio of 4:1:1 (SrCl₂: Activated Carbon: Ethyl Cellulose). A mixture of 8 grams of SrCl₂ and 2 grams of activated charcoal was ground. The mixture was then dissolved in 100 ml distilled water with magnetic stirring at 60 degree Celsius for 30 minutes to obtain a Solution A. Another solution B was prepared using 2 grams of ethyl cellulose in 100 ml isoamyl acetate with magnetic stifling at 60 degree Celsius for 30 minutes. Solutions A and B were mixed with magnetic stirring at 65 degree Celsius for 2 hours to obtain the ink composition of the present invention.

### Spray Coating of the Ink Composition on Finned Tubes: at a Pressure of 60 to 70 psi

Spray coating of the ink composition was done in accordance with the following steps:
1. The above prepared ink is filled in spray gun and spray coated in between the fins of the finned tubes
2. After one layer of coating, the coating is allowed to dry in the oven at 70 degree Celsius for 1 hour.
3. the above step is repeated till the completion of 14th layer
4. After 15th layer of coating, the coating is allowed to dry in oven at 100 degree Celsius for 45 minutes.
5. the above step is repeated till the completion of 29th layer

### EXAMPLE 3

### Ink Composition Comprising: Multi Walled Carbon Nanotubes (MWCNTs) Ink Preparation

1 gram carbon nanotubes are mixed with 4 gram Ethyl Cellulose and 50 ml iso-amyl acetate with constant stifling. A uniform solution is obtained.

### Spin Coating of Ink Composition on a Pretreated Stainless Steel Substrate

Pretreatment of stainless steel substrate is done by ultra-sonication in 1 M HNO₃ for 5 minutes and then in 4M HCl for 5 minutes. Spin coating of the ink composition is then done on the substrate using laurell spin coater at 1000 rpm for 1 minute.

### Coating of Ink Composition on a Polyethylene Terephthalate (PET) Sheet

The ink was coated on substrate using spin coating at 1000 rpm for 1 minute. The process is repeated 4 times. A thin film was separated out from the substrate. The ink is again coated on a Polyethylene terephthalate (PET) sheet using spray coating. A thin film was formed and was separated from the substrate.

### SPECIFIC EMBODIMENTS ARE DESCRIBED BELOW

An ink composition for printing on a substrate comprising a conductive material, ethyl cellulose as a binder; and a solvent selected from the group consisting of isoamylacetate and isoamylacetate-water mixture.

Such an ink composition, wherein the conductive material is a thermally and/or electrically conductive material selected from the group consisting of a metal, metal salt, polymer and ceramic.

Such an ink composition, wherein conductive material is selected from the group consisting of Calcium chloride (CaCl₂), Strontium chloride (SrCl₂), Lithium manganese oxide (LiMnO₂), single-walled carbon nanotubes and multi-walled carbon nanotubes.

Such an ink composition, wherein when the conductive material is selected from the group consisting of Calcium chloride (CaCl₂) and Strontium chloride (SrCl₂), the ink composition further comprises activated charcoal.

Such an ink composition, wherein the conductive material, activated charcoal and ethyl cellulose are in a weight ratio of 4:1:1.

Such an ink composition, wherein the substrate is made of a material selected from the group consisting of a polymer, glass and metal.

Such an ink composition, wherein the substrate is a flexible substrate.

Such an ink composition, wherein the conductive ink composition is printed on the substrate by spray coating or spin coating.

A method of preparing an ink composition for printing on a substrate, the method comprising mixing a conductive material with ethyl cellulose in a solvent selected from the group consisting of isoamylacetate and isoamylacetate-water mixture.

### INDUSTRIAL APPLICABILITY

The invention paves way for various applications including but not limited to flexible photovoltaics, flexible lithium ion batteries, flexible conducting electrodes for electronic devices, transparent conducting electrodes, solar thermal absorber coatings and solar cooling applications (Vapor absorption refrigeration systems), paper phototvoltaics etc. The advantages of the present invention are low cost, easily available solvents and binder, easy removal of the solvents after coating, room temperature process, easy to handle and one process can be used for several applications. Additionally, the problems like smudging and smearing of ink on the substrate were solved by the present invention.

We claim:

1. An ink composition for printing on a substrate comprising:
a conductive material;
ethyl cellulose as a binder; and
a solvent selected from the group consisting of isoamylacetate and isoamylacetate-water mixture.

2. An ink composition as claimed in claim 1 wherein the conductive material is a thermally and/or electrically conductive material selected from the group consisting of a metal, metal salt, polymer and ceramic.

3. An ink composition as claimed in claim 2 wherein conductive material is selected from the group consisting of Calcium chloride (CaCl₂), Strontium chloride (SrCl₂), Lithium manganese oxide (LiMnO₂), single-walled carbon nanotubes and multi-walled carbon nanotubes.

4. An ink composition as claimed in claim 3 wherein when the conductive material is selected from the group consisting of Calcium chloride (CaCl₂) and Strontium chloride (SrCl₂), the ink composition further comprises activated charcoal.

5. An ink composition as claimed in claim 4 wherein the conductive material, activated charcoal and ethyl cellulose are in a weight ratio of 4:1:1.

6. An ink composition as claimed in claim 1 wherein the substrate is made of a material selected from the group consisting of a polymer, glass and metal.

7. An ink composition as claimed in claim 6 wherein the substrate is a flexible substrate.

8. An ink composition as claimed in claim 1 wherein the conductive ink composition is printed on the substrate by spray coating or spin coating.

9. A method of preparing an ink composition for printing on a substrate, the method comprising:
mixing a conductive material with ethyl cellulose in a solvent selected from the group consisting of isoamylacetate and isoamylacetate-water mixture.
